(19) United States
(12) Patent Application Publication
(10) Pub. No.: US 2002/0157515 A1
(43) Pub. Date: Oct. 31, 2002

(54) Automated fence control coupling system

(76) Inventor: Spencer B. Dick, Portland, OR (US)

Correspondence Address: KOLISCH, HARTWELL, DICKINSON McCORMACK & HEUSER, Suite 200, 520 S.W. Yamhill Street, Portland, OR, 97204, US

(21) Appl. No.: 10/104,492

(22) Filed: Mar. 22, 2002

Related U.S. Application Data
(63) Continuation-in-part of application No. 09/578,806, filed on May 24, 2000, now abandoned.

(51) Int. Cl. B26D 7/06

(52) U.S. Cl. 83/438; 83/467.1; 83/468.7

(57) ABSTRACT

A digital fence positioning system is mounted to a preexisting table saw by clamping the digital fence positioning system directly to the fence rail. A clamping device includes two clamps positioned near opposite ends of a guide rail for a fence. Each clamp has top and bottom portions that can be secured to encompass a circular surface of the guide rail.

### CROSS-REFERENCE TO RELATED APPLICATION

This application is a continuation-in-part of application Ser. No. 09/578,806 filed May 24, 2000 titled “Automated Fence Control Coupling System” which is hereby incorporated by reference.

### FIELD OF THE INVENTION

The invention relates to saws. In particular, the invention involves an after-market accessory for mounting a digital fence positioning system on a table saw.

### BACKGROUND OF THE INVENTION

Table saws are often equipped with a moveable fence to allow the operator to set desired cut dimensions. Table saw fences typically are moveable along a guide rail that is bolted along one side of the table saw. An operator can slide the fence back and forth along the guide rail and then lock the fence in place by means of a locking handle. Many such table saws are sold in a design that requires manual adjustment of the fence.

Sometimes it is desirable to use a table saw in an automated or semi-automated capacity. Digital positioning systems are available for adding onto a table saw that has a manually operable fence. After market automated fence positioning systems may be cumbersome to install. Some positioning systems require replacement of the fence and the rail. Such an overhaul procedure is time consuming and may require a relatively high level of mechanical skill.

Another type of automated fence positioning system is designed for mounting on a preexisting rail, and for use with the preexisting fence and positioning clamp. This approach requires the purchaser to bolt the positioning system to the table via brackets. Mounting of the positioning system on the saw can be challenging because it is critical that the positioner guide rail be aligned precisely in parallel with the preexisting fence rail. It can be difficult and time consuming to achieve proper alignment of the positioning guide and the fence rail.

Another problem with prior automated fence positioning systems is that different table saws have different table and bolt configurations so that one bracket design may not be universally functional to mount the system on different saw configurations.

### SUMMARY OF THE INVENTION

The invention provides a system and method for adding an automated fence positioning system to a preexisting table saw. The fence positioning system operates with a preexisting fence and associated guide rail for directing movement of the fence. The positioning system includes a controller mounted in a fixed position on a separate positioner guide rail or channeling member, and a fence mover or positioner that is connected to the fence. The positioner moves along the positioner guide rail, and is operated by the controller. The positioner guide rail is directly clamped to opposing ends of the preexisting fence rail. The direct clamping mechanism allows the rails to be aligned easily in a parallel relationship so that the fence positioning system functions properly.

### DESCRIPTION OF THE FIGURES

FIG. 1 is a perspective view of a table saw with an after-market automated fence positioning system.

FIG. 2 is a perspective view of a table saw, according to a preferred embodiment of the invention, showing a positioner guide rail clamped directly to a preexisting fence rail.

FIG. 3 is a side view of the table saw shown in FIG. 2.

FIG. 4 is a close-up view of the clamp and rails shown in FIG. 3.

### DESCRIPTION OF THE INVENTION

The invention provides a simplified system and method for adding an automated fence positioning system to a preexisting table saw. In particular, the invention allows a person to mount a digital fence positioning device to a table saw without dismantling the table saw, and without encountering significant difficulties aligning the fence positioner with the preexisting fence rail. The invention enables a person having less mechanical skill then was previously required, to install a fence positioning device.

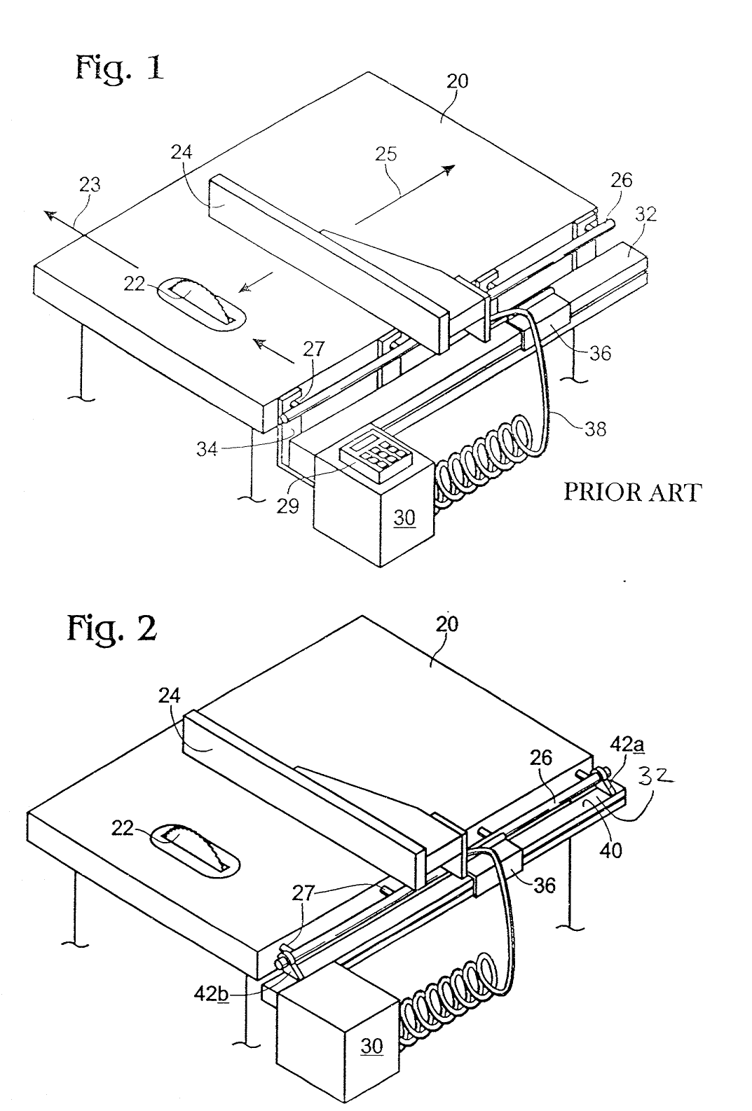

FIG. 1 shows a table saw and automated fence-positioning device in the prior art. FIGS. 2-4 show details of an improved mechanism, according to a preferred embodiment of the invention, for mounting an automated fence-positioning device on a table saw. In particular, FIGS. 2-4 show a pair of clamps that directly join the fence controller device to the preexisting rail for the fence.

In FIG. 1, table 20 employs circular saw 22 to cut wood, plastic, metal, composite, or other material in direction 23. Fence 24 is moveable back and forth in direction 25 along fence rail 26. Fence rail 26 is connected to table 20 by cross supports 27. An accessory device is added to table saw 20 to control automatically the position of fence 24 in direction 25, thus determining a dimension to cut lumber. The fence controller 29 may include a computer and a keyboard mounted on or near table 20. A drive motor and amplifier are contained in housing 30 which is connected in a fixed location to positioner guide rail 32. Positioner guide rail 32 is connected to table 20 via brackets 34 that mount on to cross supports 27. Fence positioner 36 is rigidly connected to fence 24, and is moveable, per instruction from controller 30, along positioner guide rail 32.

A number of different mechanisms may be used to move positioner 36 along positioner guide rail 32. For example, positioner 36 may be connected to a chain (not shown) inside positioner guide rail 32. The chain may be driven by one or more sprockets mounted on an axle which may in turn be driven by an electric motor. Alternatively, positioner 36 may be connected to a threaded rod inside positioner guide rail 32. An electric motor may be connected to controller 30 for rotating the threaded rod, thereby causing positioner 36 to move in direction 25 along positioner guide rail 32, and causing corresponding positioning of fence 24 on table saw 20. For example, see U.S. Pat. Nos. 5,524,514, 5,444,635, and No. 4,791,757 which each disclose drive mechanisms for moving a positioner along a rail. Each of these U.S. patents is hereby incorporated by reference. Cable 38 is a pneumatic line attached to a cylinder and solenoid mechanism which functions to lock or unlock the fence position.

Controller 30 may include a computer that is capable of memorizing one or more cut lists, for example, according to U.S. Pat. No. 5,444,635 which is hereby incorporated by reference. The computer may also be capable of optimizing a cut routine based on a desired cut list and information concerning available raw materials entered in the computer. Keypad 29 may be used to input data into the computer, and may also be used to carry out calculations. The computer may also control the drive mechanism that causes movement of fence positioner 36 along positioner guide rail 32. The controller may also be capable of memorizing common cut lengths and carrying out movement of the fence to a pre-programmed position in response to manual contact of a single key on keypad 29.

FIG. 2 shows a preferred embodiment of the invention in which many of the elements of table saw 20 are the same as shown in FIG. 1. In FIG. 2 positioner guide rail 40 is connected directly to fence rail 26 via clamps 42a and 42b. Importantly, clamps 42a and 42b are connected to fence rail 26 at extreme opposite end portions of fence rail 26 so as not to interfere with movement of fence 24 in normal operation.

As shown in FIGS. 2-4, clamps 42a and 42b are configured to extend in a downwardly diagonal orientation so that the fence controller device is ultimately positioned outward and down slightly from table 20 and fence rail 26.

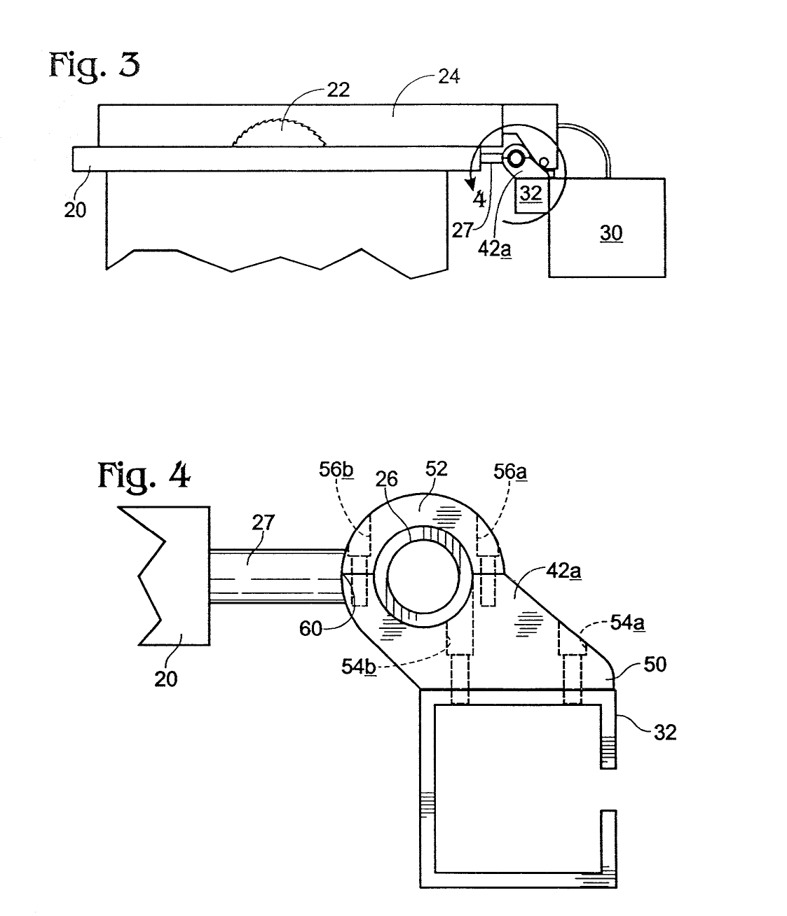

FIG. 3 shows a side view of the table in FIG. 2. FIG. 4 shows a portion of FIG. 3 expanded to focus on clamp 42a for connecting positioner guide rail 32 directly to fence rail 26. Clamp 42a has lower portion 50 that is bolted to upper portion 52. Bolt holes are shown in dashed lines. Specifically, bolt holes 54a and 54b are provided for coupling lower portion 50 of clamp 42a to positioner guide rail 32. Bolt holes 56a and 56b are provided for coupling upper portion 52 of clamp 42a to lower portion 50. When the digital fence controller device is properly installed, interface line 60 between upper portion 52 and lower portion 50 of clamp 42a is substantially horizontal or parallel to the surface of table 20.

Clamps 42a and 42b allow a person having minimal mechanical skill easily to mount a digital fence controlling system without dismantling preexisting hardware. Precise alignment of the positioner guide rail in parallel with the fence rail is achieved simply by bolting the clamps on to opposite ends of the fence rail.

Although the invention has been disclosed in its preferred forms, the specific embodiments thereof as disclosed and illustrated herein are not to be considered in a limiting sense, because numerous variations are possible. Singular terms used herein do not preclude the use of more than one of the associated element, and embodiments utilizing more than one of a particular element are within the spirit and scope of the invention. Applicant regards the subject matter of his invention to include all novel and nonobvious combinations and subcombinations of the various elements, features, functions, and/or properties disclosed herein. The following claims define certain combinations and subcombinations of features, functions, elements, and/or properties that are regarded as novel and nonobvious. Other combinations and subcombinations may be claimed through amendment of the present claims or presentation of new claims in this or a related application. Such claims, whether they are broader, narrower, equal, or different in scope to the original claims, also are regarded as included within the subject matter of applicant's invention.

I claim:

1. In a table saw including a fence that moves along a fence rail to position material for cutting, and an after market automated fence positioning system including a fence positioner that moves along a positioner guide rail, the fence positioner being connected to the fence, the positioner guide rail being spaced from and parallel to the fence rail, the improvement comprising
a pair of clamp devices each of the fence rail and the positioner guide rail having first and second corresponding end portions, one of the clamp devices connecting the first end portion of the fence rail directly to the first end portion of the positioner guide rail, and the other clamp device connecting the second end portion of the fence rail directly to the second end portion of the positioner guide rail.

2. The device of claim 1, wherein the clamp device holds the positioner guide rail in parallel with the fence rail without interfering with a functional range of movement of the fence back and forth along the fence rail.

3. The device of claim 1, wherein each clamp device includes two clamp members, each clamp member having a top and bottom portion configured to grip cooperatively a portion of a cylindrical rail.

4. The device of claim 1, wherein each clamping device extends diagonally downward from the fence rail.

5. The device of claim 1, wherein the fence positioning rail is in the form of a rectangular tube having a linear channel.

6. The device of claim 1, wherein the fence positioning rail has a top side, each clamp device being rigidly connected to the top side of the fence positioning rail.

7. A table saw having a first rail that guides movement of a fence,
a fence controller having a positioner connected to the fence and a second rail that guides movement of the positioner, and
a clamp device joining the second rail directly to opposite ends of the first rail.

8. The saw of claim 7, wherein the clamp device includes two clamp members, each clamp member having a top and bottom portion configured to grip cooperatively a portion of a cylindrical rail.

9. The device of claim 7, wherein the clamping device extends diagonally downward from the fence rail.

10. The device of claim 7, wherein the second rail is in the form of a rectangular tube having a linear channel.

11. The device of claim 7, wherein the second rail has a top side, the clamp device being rigidly connected to the top side of the second rail.

12. A linkage device for directly connecting first and second rigid parallel longitudinal members comprising
a plurality of clamps, each clamp having a lower portion and an upper portion, wherein the lower portion has a planar bottom surface for fixedly contacting an upper planar surface of the first longitudinal member, and a top semicircular surface for fixedly contacting a lower surface of the second longitudinal member, and
wherein the upper portion of each clamp has a bottom semicircular surface corresponding to the top semicircular surface of the lower portion, so that the semicircular surfaces of each clamp can cooperatively encompass a circular surface of the second longitudinal member.

13. A control device for operating a fence on a table saw, comprising:
a fence positioner that connects to a fence on a table saw and automatically moves the fence along a fence rail structure;
a positioner guide rail that guides the fence positioner;
a motor operatively connected to the fence positioner and adapted to move the fence positioner along the positioner rail; and
a removable clamp device that rigidly connects the positioner guide rail directly to the fence rail structure.

14. The device of claim 13, wherein the clamp device connects the positioner guide rail substantially parallel to the fence rail structure.

15. The device of claim 13, wherein the clamp device includes clamps that are attached near the ends of the fence rail structure.

16. A cutting apparatus comprising:
a table saw including a fence structure that is movable along a fence guide rail,
a drive mechanism connected to the fence structure for automatically moving the fence structure along the fence guide rail, the drive mechanism including a fence positioner connected to the fence structure, and a positioner guide rail for coordinating movement of the fence positioner, and
a removable clamp device that directly connects the positioner guide rail parallel to the fence guide rail.
